(19) United States
(12) Patent Application Publication
(10) Pub. No.: US 2026/0079080 A1
(43) Pub. Date: Mar. 19, 2026

(54) METHOD OF TESTING SUSPENSION STRUT BEARING UNCLIPPING FORCE

(71) Applicant: FCA US LLC, Auburn Hills, MI (US)

(72) Inventors: Jun Justin Hua, Shanghai (CN); JunJun HUANG, Shanghai (CN); Xiaoliang PENG, Shanghai (CN); Jie FANG, Shanghai (CN)

(21) Appl. No.: 18/887,197

(22) Filed: Sep. 17, 2024

(51) Int. Cl. G01M 17/04; G01L 5/00

(52) U.S. Cl. CPC G01M 17/04; G01L 5/00

(57) ABSTRACT

A method of testing a strut of a vehicle includes aligning a top mount of a portion of a strut assembly with an opening in a test surface and aligning a rod with a spring isolator. The spring isolator includes a spring seat. The method also includes applying force with a force generator through the rod on the spring seat. The rod is coupled to a force sensor. The method also includes increasing the force on the spring seat until spring seat and bearing are unclipped and displaying a maximum force from a force signal of the force sensor as an unclipping force.

### FIELD

The present disclosure relates generally to suspensions for automotive vehicles and, more specifically, to a method of testing an unclipping force of a strut bearing of a suspension.

### BACKGROUND

This section provides background information related to the present disclosure which is not necessarily prior art.

Many vehicles have a strut that has spring associated therewith. When the strut and spring are disassembled, the bearing may be unclipped and cause the bearing to lose function. In order to determine an unclipping force, the bearing is tested typically by fixing a steel wire on a bearing spring seat and pulling the wire with a dynameter until the spring seat is unclipped. The maximum force of the dynameter is the unclipping force. However, this test solution does not simulate a real failure mode since the test result is not a real spring force. That is, because the current test is used to pull the edge of the spring seat, the test result is not the real spring force applied at the seat.

### SUMMARY

This section provides a general summary of the disclosure, and is not a comprehensive disclosure of its full scope or all of its features.

A testing system is provided that applies a force to a spring seat with a rod to better simulate a maximum unclipping force before the spring seat and the bearing are unclipped.

In one aspect of the disclosure, a method of testing a strut of a vehicle includes aligning a top mount of a portion of a strut assembly with an opening in a test surface and aligning a rod with a spring isolator. The spring isolator includes a spring seat. The method also includes applying force with a force generator through the rod on the spring seat. The rod is coupled to a force sensor. The method also includes increasing the force on the spring seat until spring seat and bearing are unclipped and displaying a maximum force from a force signal of the force sensor as an unclipping force.

In another aspect of the disclosure, a testing system includes a testing table receiving a strut assembly portion having a spring isolator of a spring seat. A force system has a force generator, a rod having an end coupled to the force generator and a force sensor generating force signals corresponding to a force exerted at the rod on the spring isolator of the strut assembly portion. A display displays a maximum force based on the force signal.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagrammatic view of a vehicle having a strut to be tested according to the present disclosure.

FIG. 2 is an example of a strut that may be tested.

FIG. 3 is a cross-sectional view of a strut portion on a testing table.

FIG. 4 is a flowchart of a method for performing the test of a strut.

FIG. 5 is an example of a display with a message thereon for displaying the unclipping force.

### DETAILED DESCRIPTION

Example embodiments will now be described more fully with reference to the accompanying drawings.

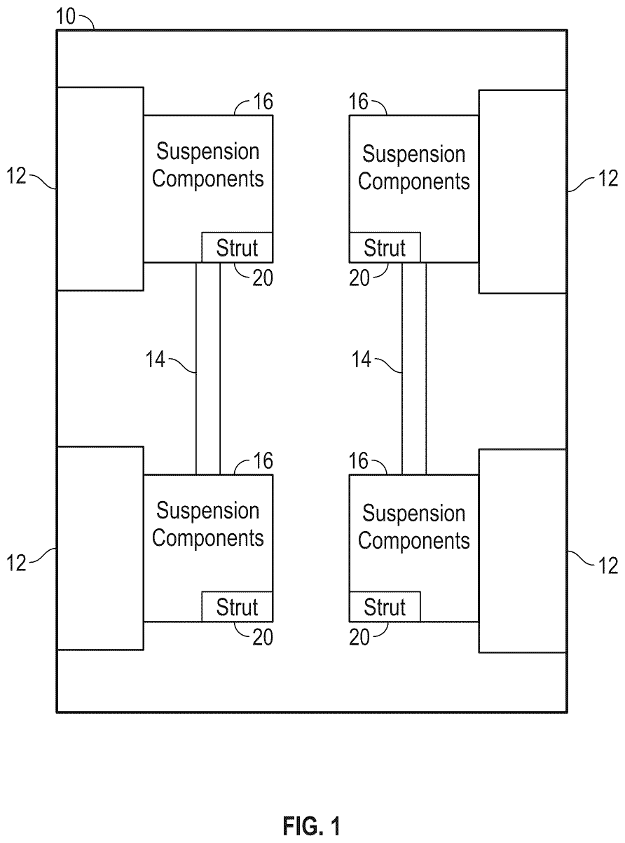

Referring now to FIG. 1, a vehicle 10 having wheels 12 is illustrated. The wheels 12 are fastened to a vehicle support structure, such as the vehicle frame 14. The suspension components 16 are used to couple the wheels 12 to the frame 14. The suspension components 16 are illustrated adjacent to each of the wheels 12. The suspension components may include a strut 20 in the various vehicles.

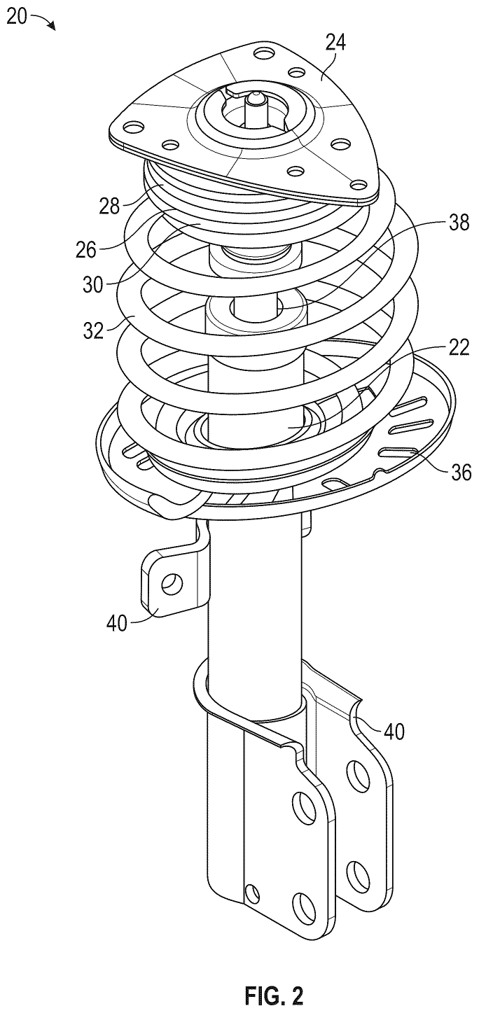

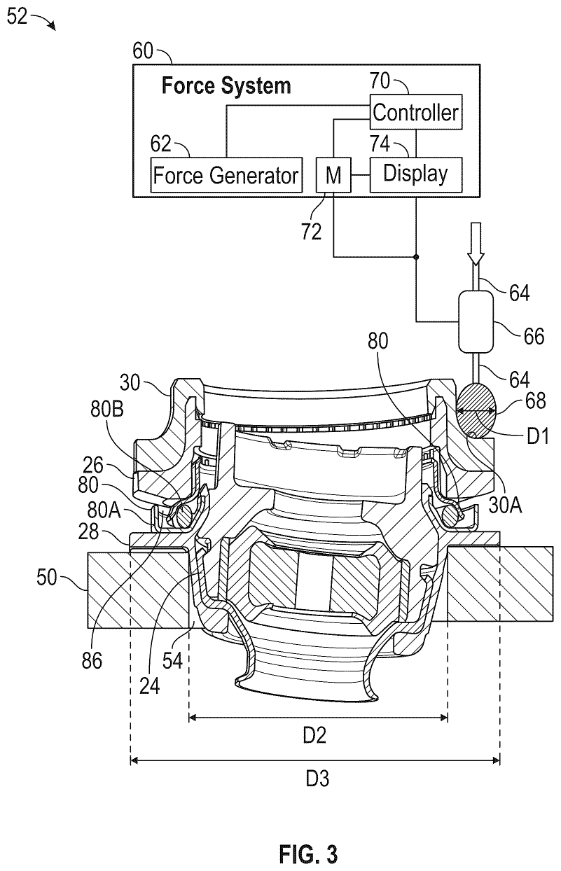

Referring now to FIGS. 2 and 3, the strut 20 includes a strut body 22 that has an upper strut mount 24 that is used to secure the strut to the vehicle. The upper strut mount 24 has a bearing spring seat 26 that is disposed below a flange 28 of the upper strut mount 24. The bearing spring seat 26 has a spring isolator 30 that is directly adjacent to the spring 32. The spring 32 is received in a spring pocket 30A what has a diameter D1 corresponding to the diameter of the spring 32. A lower spring seat 36 secures the spring 32 between the bearing spring seat 26 around a bump stop 38. A mount 40 is used for coupling the strut 20 to the vehicle 10 at both the suspension and wheel bearing. Several types and shapes of the mount 40 may be employed depending on the vehicle.

A testing table 50 is illustrated for testing at least a portion 52 of the strut 20. The testing table 50 has an opening 54 having a diameter D2 sized to receive at least a portion of the top mount 24. As mentioned above, the top mount 24 has a flange 28 that is positioned on the top of the testing table 50. The flange D3 has a diameter D3 greater than D2. The top mount 24 extends at least partially through the opening 54. As illustrated, the assembly portion 52 is inverted in that it is illustrated opposite to the direction it would be assembled in the vehicle 10. In this example, a force system 60 has a force generator 62 that is used to generate a force on a rod 64. The rod 64 has a force sensor 66 coupled thereto. The rod 64 has an end 68 that is round in shape. The end 68, in this example, is a ball that has the D1 diameter that is the same as the diameter of the spring 32 illustrated in FIG. 2. In this example, the spring 32 has been removed from the subassembly 52 so that the end 68 is received in the spring isolator 30 that is coupled to the spring seat 26. The force generator generates a plurality of forces 62 and may be automated by a controller 70. The force may be increased to find the maximum or unclipping force. The force sensor 66 generates a force signal that corresponds to the force being applied to the end 68 at the spring isolator 30. A memory 72 may store the forces applied by the force generator 62. A display 74 may generate the unclipping force when unclipping a bearing 80. That is, a bearing 80 is disposed between the bearing spring seat 26 and the top mount 24. In this example, the bearing 80 is disposed directly adjacent to the flange 28 and extends into the spring seat 26. That is, the bearing has a first portion 80A and a second portion 80B that are coupled to the respective top mount 24 and the bearing spring seat 26. An unclipped position 86 illustrates where the two bearing portions 80A, 80B may come apart when the unclipping force is reached. If the system is automated, the memory 72 may be a non-transitory computer readable medium including machine readable instructions that are executable by the processor or controller 70. The machine readable instructions include instructions for performing a force for determining an unclipping force of a strut.

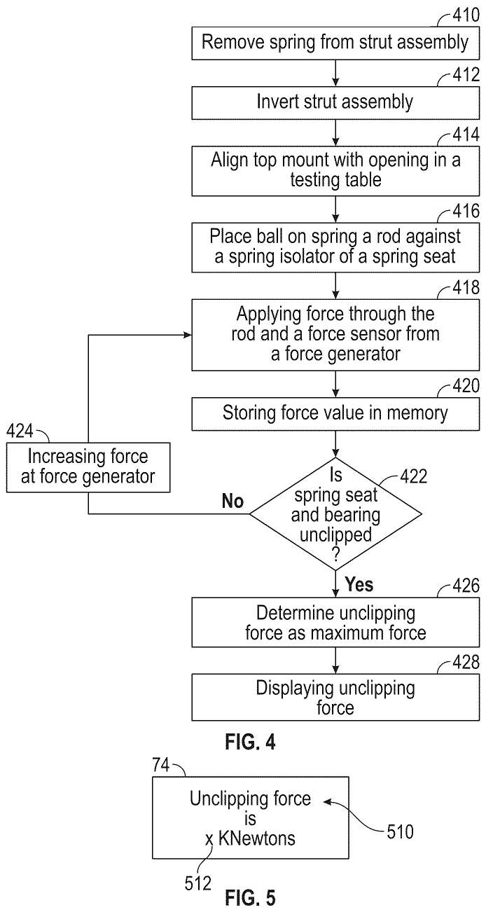

Referring now to FIG. 4, a method for performing the test is set forth. In step 410, the spring is removed from the strut assembly so that the spring isolator 30 is exposed. In step 412, the strut assembly or the assembly portion is inverted. In step 414, the top mount of the strut is aligned with an opening in a testing table so that at least a portion of the top mount extends through an opening in the testing table.

In step 416, the force system 60 is placed adjacent to the strut or strut portion so that an end 68 that has the diameter D1 similar to or the same as the spring that has been removed is placed into the spring isolator 30. The end 68 is positioned at the end of a rod 64 and force sensor 66 is also coupled to the force system 60. The force generator 62 generates a force down the rod in step 418. The force is applied through the rod and the force sensor 66 from the force generator 62. Force signals corresponding to forces are generated at the force sensors 66 and are communicated to the display 74 and may also be stored in the memory 72 in step 420. In step 422, it is determined whether the spring seat and the bearing have become unclipped. A rapid change in the force being displayed at the display 74 or being stored in the memory 72 as determined by the controller 70 may be used in this determination. When the spring seat and the bearing are clipped, step 424 increases the force at the force generator 62. That is, the forces are repeatedly increased until unclipping. The increased force is transmitted to the spring isolator 30 and the spring seat 26 and steps 418, 420 and 422 are performed repeatedly.

Referring back to step 422, when the spring seat and the bearing have been unclipped, step 426 is performed. Determining unclipping is done when the force value drops rapidly. In step 426, the unclipping force is determined at the maximum force at the controller 70. The maximum force or the unclipping force is displayed at the display 74 in step 428.

Referring now to FIG. 5, a display 74 having an unclipping force message 510 is set forth. The unclipping force message may display the unclipping force in Kilonewtons which corresponds to the maximum force applied by the force generator 62 just prior to or at the time of the unclipping of the bearing 80. In this example, “X” represents the maximum clipping force value which corresponds to a number.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and ““they”” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be taken.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method comprising:
aligning a top mount of a portion of a strut assembly with an opening in a test surface;
aligning a rod with a spring isolator, the spring isolator comprising a spring seat;
applying force with a force generator through the rod on the spring seat, the rod coupled to a force sensor;
increasing the force on the spring seat until spring seat and bearing are unclipped; and
displaying a maximum force from a force signal of the force sensor as an unclipping force.

2. The method of claim 1 further comprising repeatedly performing the step of increasing the force to obtain a plurality of force signals and storing the plurality of force readings in a memory of a force system.

3. The method of claim 2 further comprising determining the maximum force reading from the plurality of force signals.

4. The method of claim 1 wherein prior to aligning the top mount, inverting the strut assembly.

5. The method of claim 1 wherein prior to aligning the top mount, removing a spring from the strut assembly.

6. The method of claim 1 wherein aligning the top mount comprises aligning the top mount so a flange of the top mount is disposed at least partially around the opening.

7. The method of claim 1 wherein aligning the rod comprises aligning an end of the rod with the spring isolator of the spring seat.

8. The method of claim 7 wherein aligning the end of the rod comprises aligning a ball on the end of the rod with the spring isolator.

9. The method of claim 8 wherein aligning the ball on the end of the rod with the spring isolator comprises aligning the ball having a diameter of a spring pocket of the spring isolator.

10. A testing system comprising.
a testing table receiving a strut assembly portion having a spring isolator of a spring seat;
a force system comprising a force generator, a rod having an end coupled to the force generator and a force sensor generating force signals corresponding to a force exerted at the rod on the spring isolator of the strut assembly portion; and
a display displaying a maximum force based on the force signal.

11. The testing system of claim 10 wherein said force system further comprising a controller determining the maximum force as an unclipping force based on the force signals.

12. The testing system of claim 10 further comprising a memory storing a plurality of force values based on the force signals.

13. The testing system of claim 10 wherein the end is disposed within a pocket of the spring isolator.

14. The testing system of claim 13 wherein the end comprises a ball.

15. The testing system of claim 14 wherein the ball comprises a first diameter.

16. The testing system of claim 15 wherein the pocket comprises a second diameter and wherein first diameter is equal to the second diameter.

17. The testing system of claim 10 wherein the testing table comprises an opening therethrough for receiving at least a portion of the strut assembly.

18. The testing system of claim 17 wherein the portion of the strut assembly comprises a top mount.

19. The testing system of claim 18 wherein the top mount comprises a flange sized greater than the opening.

20. The testing system of claim 19 wherein the flange comprises a flange diameter greater than an opening diameter of the opening.
